(19) United States
(12) Patent Application Publication
(10) Pub. No.: US 2016/0132601 A1
(43) Pub. Date: May 12, 2016

(54) Hybrid Explanations In Collaborative Filter Based Recommendation System

(71) Applicant: Microsoft Technology Licensing, Redmond, WA (US)

(72) Inventors: Nir Nice, Kfar Veradim (IL); Noam Koenigstein, Raanana (IL); Shay Ben-Elazar, Tel Aviv (IL)

(21) Appl. No.: 14/538,894

(22) Filed: Nov. 12, 2014

(51) Int. Cl. G06F 17/30

(52) U.S. Cl. CPC G06F 17/30867; G06F 17/3053

(57) ABSTRACT

Example apparatus and methods produce an explanation of why a recommendation is being made by an automated collaborative filtering recommendation system. The explanation may include feature categories and features that describe the item being recommended. The feature categories selected and features selected may depend on a personalization level for an item associated with the recommendation, a quality level of the descriptiveness of a feature for the recommendation, and correlations between items and features analyzed by the recommendation system. The feature categories and features may be selected based on an aggregate score that considers and combines the personalization level, the quality level, and the correlations. The quality level may be human curated or may vary directly with the ability of a feature to partition a feature space. Correlations between items and features reflect the degree to which the features are exhibited by the items.

### BACKGROUND

Recommendation systems provide a discovery experience for shoppers and users. There are two major types of conventional recommendation systems: collaborative filtering based systems and feature based systems. Feature based systems may also be referred to as content based systems. Collaborative filtering (CF) depends on actual user events, for example a user consuming (e.g., buying/watching/reading) an item. CF systems may tell a user that “people who saw A also tend to see B and C.” Feature based systems describe features (e.g., author, actor, genre) of items. Feature based systems may also depend on actual user events. For example, feature based systems may tell a user that “this movie has features like this other movie.” Different techniques (e.g., matrix factorization, nearest neighbor) may be used to compute item similarities and then to provide recommendations based on the similarities. These techniques may rely on both positive indications (e.g., user purchased item, user gave item a good review) and negative indications (e.g., user did not access/purchase item, user gave item a bad review).

Conventional recommendation systems provide information about matches between users (e.g., shoppers) and items (e.g., books, videos, games) or between items and items based on user interests, preferences, history, item features, or other factors. For example, if a system has data that a user has previously accessed a set of items, then a recommendation system may identify similar items and recommend them to the user based on the data about the user's own actions (e.g., “if you liked this, you might like that”). This may be referred to as a user-to-item recommendation, a U2I reco, or as a “pick”. If a system has data that one item has features like another item, then a conventional recommendation system may also provide item-to-item recommendations or “related” recommendations (e.g., “this movie has the same actors and subject matter as this other movie”). These recommendations may be referred to as I2I recos. Conventional explanations may feel impersonal and may leave a user wondering why the recommendation system is recommending that item to them at this time.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods use curated content-based item labels about features to explain a recommendation. Given a set of items to be recommended, a score for features associated with the recommended items can be computed using both a user's history and the feature space. The score indicates how related the features are to both a recommendation and to the user history. A score may be an aggregation of different scores concerning the relatedness of a feature to the recommendation or to the items in the user history. The aggregate score may facilitate identifying features or feature categories that are common to the user history and the recommended item. An engaging, persuasive, and personalized explanation of a recommendation may then be crafted using the features or feature categories in a natural language sentence. The natural language sentence may be produced using a language-based rule set that selects highly scored keywords associated with the features or feature categories. The personalized explanation may explain why the recommendation system is providing the recommendation.

In one example, an apparatus performs integrated modular scoring that measures both the personalization and the quality of features from the point of view of providing an explanation for a recommendation. The apparatus applies a rule set to a weighted vector of labels to produce a natural language sentence associated with a sub-genre in which an item may reside. The integrated modular scoring is performed in the context of grouped recommendations to facilitate identifying clusters of common items in a sub-genre.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa.

Furthermore, elements may not be drawn to scale.

FIG. 1 illustrates an example metric space.

FIG. 2 illustrates an example sentence structure and recommendation explanation.

FIG. 3 illustrates example vectors or matrices involved in computing a feature score.

FIG. 4 illustrates one example for computing a feature score.

FIG. 5 illustrates an example apparatus associated with producing hybrid explanations in a collaborative filter based recommendation system.

FIG. 6 illustrates an example apparatus associated with producing hybrid explanations in a collaborative filter based recommendation system.

FIG. 7 illustrates an example cloud operating environment in which a recommendation system that produces an engaging, personalized hybrid recommendation explanation may operate.

FIG. 8 is a system diagram depicting an exemplary mobile communication device configured to participate in a recommendation system that produces an engaging, personalized hybrid recommendation explanation.

FIG. 9 illustrates an example method associated with producing hybrid explanations in a collaborative filter based recommendation system.

FIG. 10 illustrates an example method associated with producing hybrid explanations in a collaborative filter based recommendation system.

### DETAILED DESCRIPTION

Example apparatus and methods provide a recommendation system that produces an engaging personalized hybrid message to accompany a recommendation. The message may be an explanation that accompanies a recommended item to explain the choice to the user. The message may be, for example, a short textual description. In user-to-item recommendations (U2I), the explanation is crafted to improve user satisfaction metrics concerning persuasiveness, trust, transparency, or other factors. User satisfaction metrics are improved when the user feels that the recommendation system understands the user's taste without being overly familiar or obtrusive. Conventionally, a collaborative filtering (CF) based system generates explanations by describing the similarity between the recommended item and related items in a CF-space in which the user has previously shown interest. These conventional explanations may appear to provide little actual insight and thus are not engaging. Additionally, the conventional explanations may not be explicitly personalized, which can be counterproductive.

A CF recommendation system has data about a user's history. Thus, the recommendation system knows what the user has consumed (e.g., purchased, watched, read, played) before. The recommendation system also has information about features associated with items that are being considered for recommendation to the user. By evaluating a feature with respect to both how well the feature explains or distinguishes the item and with respect to how well the feature correlates to a user history, feature categories and feature labels can be selected for inclusion in a message that explains the recommendation. The message may be a “hybrid” message that has elements familiar to a user-to-item recommendation based on distances between user and item vectors and elements familiar to an item-to-item recommendation based on similarities between features. The hybrid message may be produced by a hybrid recommendation that considers a distance function A associated with a collaborative filtering latent space along with a distance function B associated with a feature embedded space.

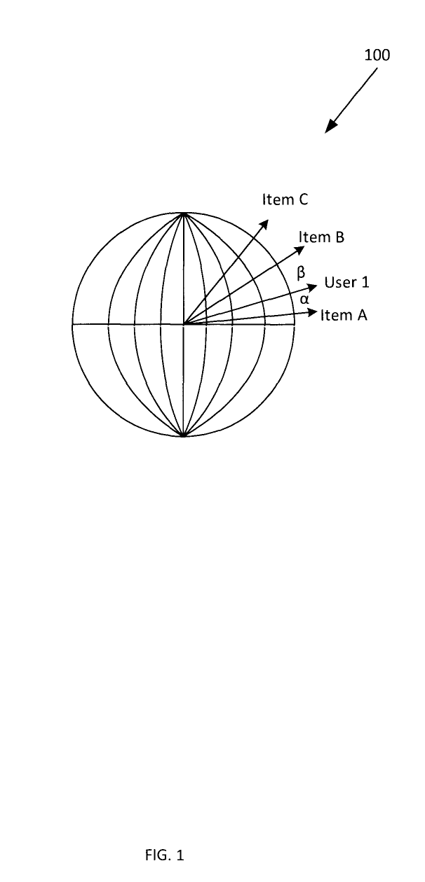

FIG. 1 illustrates a space 100 where the distance between items is defined. For example, the distance between a first vector associated with a first item (e.g., Item A) and a second vector associated with a first user (e.g., User 1) may be measured by angle α and the distance between the second vector and a third vector associated with a third item (e.g., Item B) can be measured by β. The distance between items may describe, for example, the degree of similarity of the items. While distance is illustrated being measured by angles, other distance measuring approaches may be applied. The metric space 100 may have been created by performing matrix factorization on a user-to-item usage matrix and thus the distance between a user item and vector item could be found.

At a high level, example apparatus access a set of recommended items and compute scores for features, where the scores are a function of a relationship between the feature and a recommended item and between the feature and a user's history. Features belong to feature categories. More generally, categories can be inferred using machine learning techniques. The scores for features facilitate identifying features and feature categories that may be useful for constructing explanatory sentences to accompany a recommendation. The explanatory sentences may then be built from the highest scoring or selected features or feature categories.

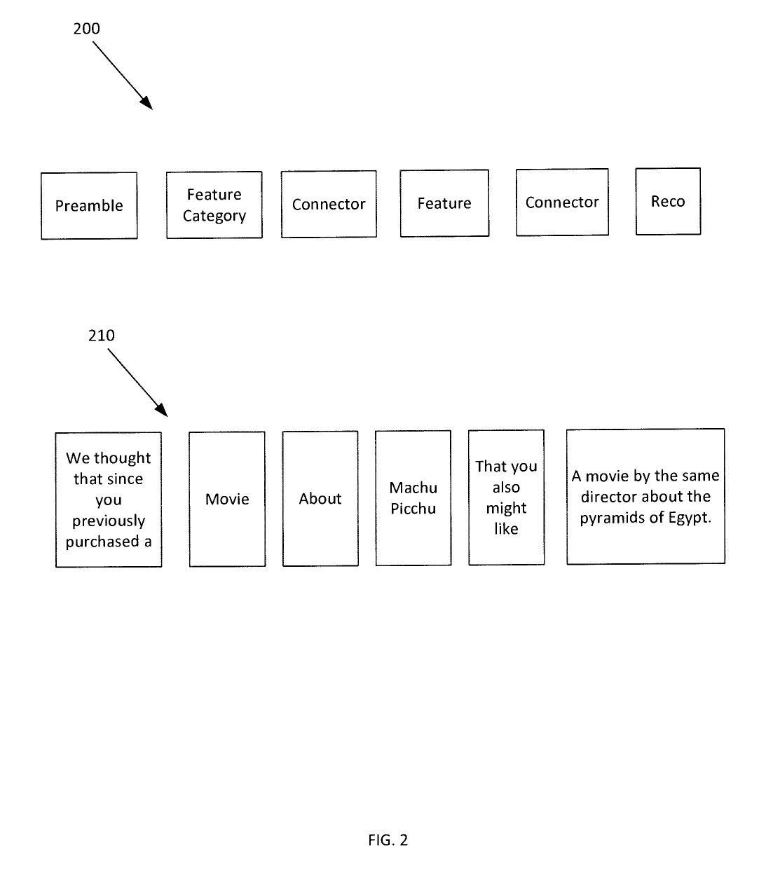

FIG. 2 illustrates an example sentence structure 200 and an example recommendation explanation 210 that fills in the blanks in sentence structure 200. The sentence structure 200 includes a preamble and slots into which text describing feature categories, features, and a recommended item can be inserted. The slots may be connected by connecting words. Recommendation explanation 210 illustrates how the slots may be filled in. Consider the following example explanatory sentences and compare them to conventional “People who bought this item also bought this item” recommendations.

Imagine that the item to be recommended is a doll of a character that appeared in an animated movie titled Soggy. The doll to be recommended is a medium sized doll of a dog that is the best friend of another character whose doll was previously purchased by the user. Example apparatus and methods may produce a recommendation sentence that reads “Since you bought the medium sized Susie pony doll featured in the movie Soggy, we thought you might also like the medium sized Franky dog doll from Soggy because Franky dog is the best friend of Susie pony.” While the doll may have a dozen features, focusing on certain features from certain feature categories may help guide a user to a better informed decision. For example, having dolls that were friends in a popular movie may be important to children and having dolls that are the same size may also be important to the purchaser who would not want to have to return a wrong-sized doll. This explanatory sentence is superior to conventional presentations because it could inform a grandfather that he was buying the right doll to go along with a previous purchase for his granddaughter and could provide the grandfather with information about why the doll is important to his granddaughter.

Imagine that the item to be recommended is a poster of a red turtle dressed in a private's uniform. The poster to be recommended is a 24×48 poster of a turtle that is part of a group of turtles. A previous 24×48 poster was purchased illustrating a blue turtle in a sergeant's uniform. Example apparatus and methods may produce a recommendation sentence that reads “Since you bought the 24×48 poster of the red turtle dressed in a sergeant's uniform, we thought you might also like the same sized poster of the blue turtle dressed in a private's uniform because the blue turtle private could be in the same squad as the red turtle sergeant. This explanatory sentence is superior to conventional presentations because it could tell a prospective purchaser why the birthday gift they are selecting is important to the person for whom it is being purchased.

Imagine that the item to be recommended is a DVD of the television series Cranford by Elisabeth Gaskell. The recommendation may be based on the fact that the user had previously viewed, ranked, and shared another DVD by Elisabeth Gaskell. There are many features for media content, which may include the author, the actors, and the media upon which the content was previously consumed. Thus, from the many (e.g., hundreds) of features available for a movie, example apparatus and methods may produce a recommendation sentence like “Since you previously enjoyed the DVD of Wives and Daughters by Elisabeth Gaskell, we invite you to consider the DVD for Cranford by Mrs. Gaskell because it is set in the same era, has the same director, and concerns the same subject matter (e.g., coming of age in changing Victorian England)”. This explanatory sentence reveals the feature categories of media format, author, era, director and subject matter. This explanatory sentence also provides values for some of these categories. Thus the user may be able to make an informed decision about whether to consume the recommended item.

Conventional matrix factorization models map users and items to a joint latent factor space and model user-item interactions as inner products in the joint latent factor space. An item may be associated with an item vector whose elements measure the extent to which the item possesses some factors. Thus, conventional systems tend to rely on user-item affinity to identify which items in a user's history are related to a recommended item. Similarly, a user may be associated with a user vector whose elements measure the extent of interest the user has in items that are high in corresponding factors. The dot product of the vectors may describe the interaction between the user and item and may be used to determine whether to make a recommendation to a user. More specifically, every user i may be assigned a vector uᵢ in a latent space, and every item j may also be assigned a vector vⱼ in the latent space. The dot product uᵢ·vⱼ represents the score between the user i and the item j. The score represents the strength of the relationship between the user i and the item j and may be used to make a recommendation (e.g., recommend item with highest score).

After all the items j have been scored, the highest scoring items may be selected and recommended. In user-to-item recommendations, recommended items may be presented to the user and may be accompanied by a short message or explanation. While conventional systems may have provided interesting and relevant results, sub-optimal recommendations or explanations concerning recommendations may have occurred for different reasons. For example, a collaborative-based similarity may have provided an inadequate explanation concerning a recommendation. Users may want to feel like a more personalized or more individualized recommendation has been made based on their own experiences rather than on the experiences of a population or demographic. Additionally, the item similarity in the latent space may be confusing or difficult to understand. For example, some items may group together or “stick together” in a collaborative filter space due to factors including time dependence or inherent user behaviors that may confound a recommendation system since the system may not model these factors explicitly. When items have stuck together based on some confounding factor that is not explicitly modeled, the explanation attached to the recommendation may be unnatural or unrelated to factors upon which a user may generally make a decision. Providing an unnatural or inexplicable rationale for a recommendation may not increase user trust and may actually harm user trust significantly.

Example apparatus and methods provide a hybrid approach for making a recommendation that integrates per-item content-based features into explanations that accompany a recommendation. One embodiment employs a two stage approach. First, scores for features and categories associated with the features may be computed for items that are being considered for recommendation to a user. After the scores are computed, a short description may be assembled for an item being considered for recommendation by applying a predefined rule-set on features or feature categories with the highest scores. The scores may be computed using a plurality of heuristics that contribute to the amount of personalization, the quality of the explanation, the quality of the available features, or other factors. Example heuristics may be modular. Since the example heuristics are modular, the contribution from any particular heuristic may be tuned with corresponding hyper-parameters. In one embodiment, if the short description has a value that exceeds a threshold, then the recommendation may be presented to the user, otherwise no recommendation may be made if no recommendation is considered superior to a vague, impersonal or unexplained recommendation. In one embodiment, one item may be selected from the set of candidate recommended items based on having produced a highest valued recommendation explanation.

In one embodiment, given two items that are being considered for recommendation, the item for which a better recommendation explanation can be built may be the item that is recommended. The item with the better recommendation sentence may be recommended because it may provide an enhanced user experience by providing a more personalized explainable recommendation rather than an impersonal recommendation that does not have an adequate explanation. In one embodiment, users may score recommendation explanations and the scores may be used to adjust weights in a formula for computing the score for features associated with a recommendation explanation.

In one embodiment, a module is represented as a vector or matrix. A module may provide, for example, a strength for an item (e.g., Rᵢ), a strength for a feature (e.g., Fₖ), or the correlation between items and features (e.g., Pⱼ), where i,j,k are the indices of the modules per type. The scores may be computed using an ensemble approach that treats a module as an estimator and outputs a weighted average as a candidate score. While three modules are described, a greater or lesser number of modules may be used in different embodiments.

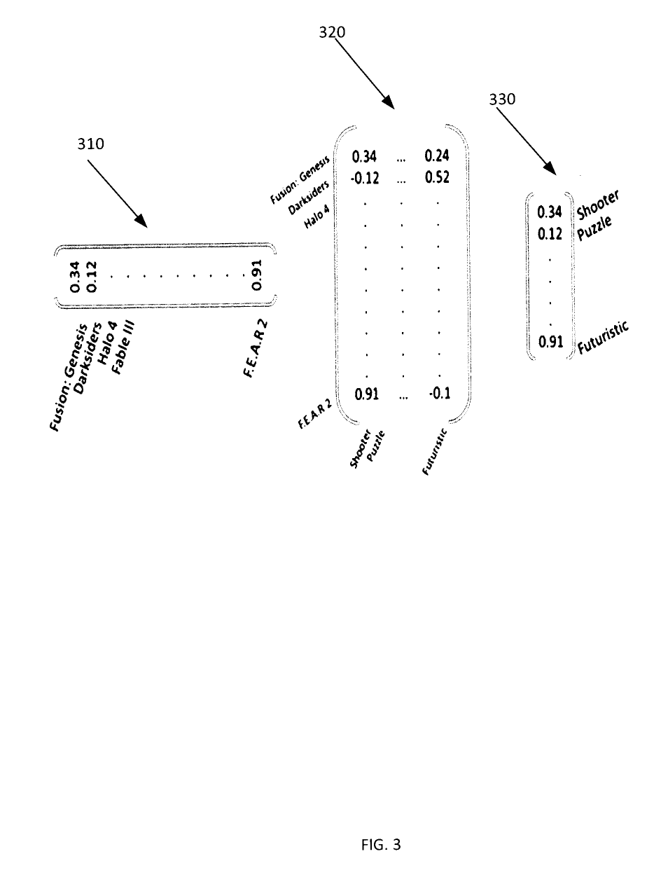

FIG. 3 illustrates data stored in vectors or matrices that may be used to compute a feature score. Data 310 represents an aggregated item strength for items. The aggregated item strength may be computed from data produced by one or more processes applying one or more heuristics. The aggregated item strength represents how closely related an item is to the item to be recommended. For example, a video game FEAR2 may have a relatively high similarity of 0.91 while another video game Darksiders may have a relatively low similarity of 0.12. The degree to which an item is similar to the item to be recommended may be factored into the calculations for which feature or feature category to use to explain the recommendation. Features or feature categories that are found in items that are more similar to the item to be recommended may be considered more important for explaining the recommendation.

Data 320 represents an aggregated item-feature correlation. The aggregated item-feature correlation may be computed from data produced by one or more processes applying one or more heuristics. The aggregated item-feature correlation represents the degree to which an item expresses a feature. For example, the score of 0.91 for the intersection of FEAR2 and shooter indicates that FEAR2 correlates well with the feature of being a shooter game while the score of 0.1 for the intersection of FEAR2 and futuristic indicates that FEAR2 does not correlate well with the feature of being a futuristic game.

Data 330 represents an aggregated feature strength. The aggregated feature strength may be computed from data produced by one or more processes applying one or more heuristics. The aggregated feature strength represents how closely the feature is associated with respect to the items that are similar to the item to be recommended. For example, the score of 0.91 for futuristic indicates that many of the items that are similar to the item to be recommended exhibit the futuristic feature while the score of 0.12 for puzzle indicates that few of the items that are similar to the item to be recommended exhibit the puzzle feature. Data 310, 320, and 330 may be input to a feature score computation process to determine scores for features. The scores for features may then be used to determine which features or feature categories to include in a recommendation explanation.

Consider a scenario where n, m represent the number of items and features accordingly and where i represents an item and j represents a feature. In this scenario, let S represent a resulting scores vector, where S is computed according to:

S=Σwᵢ·Rᵢ^{1×n}×Σwⱼ·pⱼ^{n×m}·Σwₖ·Fₖ^{m×1} [1]

where:
wᵢ represents a weight for item strengths,
wₖ represents a weight for feature strengths,
wⱼ represents a weight for correlations between items and features,
Rᵢ represents a strength for an item,
Fₖ represents a strength for a feature, and
Pⱼ represents the correlation between items and features.

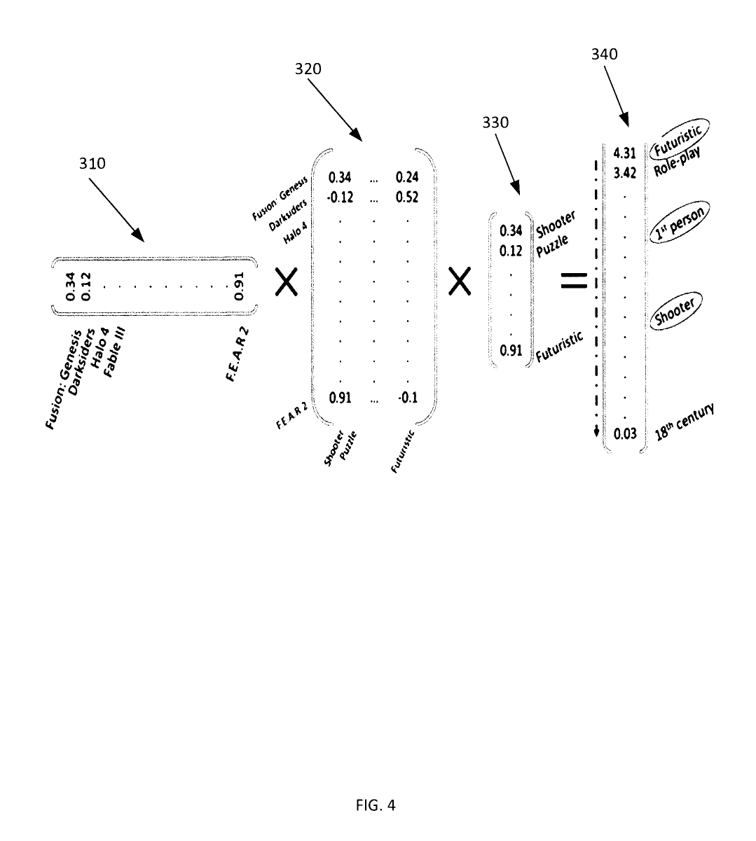

In one embodiment, S(i) is the score indicating how a feature i is related to a particular recommended item and the associated user history. FIG. 4 illustrates one way in which data 310, data 320, and data 330 can be combined to produce the vector S, which is represented as data 340. In data 340, the top two features are futuristic and role playing. Thus, a hybrid recommendation explanation may identify the feature categories associated with these features and provide the feature values. Additionally, the point of view (e.g., first person) may be considered important to a shooting game and thus the point of view may also be included.

In one embodiment, the vector S is computed for every candidate recommendation. In another embodiment, the vector S may be computed for a subset of candidate recommendations (e.g., highest one percent of recommendations, top five recommendations, recommendations above a threshold score). The features for an item may be ranked for their “explanatory power” based on the values in S. The weights wᵢ, wⱼ, wₖ are used to tune and balance the importance of the different modules. For example, increasing wₖ puts more emphasis on choosing the correct features module Fₖ while increasing wᵢ puts more emphasis on choosing the correct items module Rᵢ.

Different module types may employ multiple approaches to compute a value. For example, one approach may integrate a vector of item usage distributions and a vector measuring the distance of some or every item to the candidate recommended item. The vectors may be integrated to produce a single strength for an item. The vectors may be integrated in different ways including, for example, multiplying, adding, or otherwise combining vectors to produce the single strength for the item.

The module Rᵢ^{1×n} may weight items that are relevant for a specific candidate recommendation. Items in the neighborhood of the candidate recommended item may be more similar to the recommended item than items that are located farther away. Items in a neighborhood that are more similar to the recommended item are more important to a recommendation and to an explanation of a recommendation than items that are very different from the recommended item. In one embodiment, more emphasis is placed on items in the user's history than other items. More emphasis may be placed on an item by manipulating weights. Items in the user's history represent items the user has consumed (e.g., purchased, viewed, read, played) in the past. The module Rᵢ^{1×n} may integrate the information concerning the neighborhood, the user's history, and the recommendation.

The module Pⱼ^{n×m} may encode relations between items and features. After identifying the relevant items and weighting those relevant items according to Rᵢ^{1×n} example apparatus and methods may then “transform” the items information into a features domain. In one embodiment, the transformation is performed by multiplying the items information by a correlation matrix Pⱼ^{n×m} that encodes the affinity of items to features. The transform operation produces a vector of feature weights from a vector of item weights. The vector of feature weights integrates the information about the “importance” of the items as well as the correlation of features to items.

The vector of feature weights may be adjusted by a point-wise multiplication with another feature weights vector Fₖ^{m×1}. The vector Fₖ^{m×1} encodes the information in the features module. Vector Fₖ^{m×1} weights features based on heuristics such as their “explanatory power”. The “explanatory power” concerns the ability of the feature to provide a good explanation to a recommendation. A “good” explanation is one that may improve user satisfaction metrics in response to a user feeling more engaged, in response to a user feeling that the system understands them personally, in response to a user feeling that the explanation is relevant to their decision making process, or in response to other factors. A “good” explanation provides information upon which a user may make an informed decision that the user feels is based on relevant information.

The three example modules Rᵢ, Pⱼ, and Fₖ incorporate different approaches or heuristics to encode the importance of features, items, or the relations between features and items. Example heuristics concern feature strength and feature-item correlations. Feature strength heuristics may concern prior multipliers for keywords that have a better fit as part of an explanation or prior multipliers that have a worst fit as part of an explanation. Feature strength heuristics may also concern term frequency-inverse document frequency (TF-IDF) normalization for non-informative features that occur frequently. Feature strength heuristics may also concern a binary score multiplier that signifies if the feature exists in the recommended item. Feature-item heuristics may factorize an item:features matrix to yield a latent representation of features and items in the same space. Feature-item heuristics may measure angles between an item and a feature in the latent space to provide a signed-score that measures the correlation between an item and a feature.

Once a vector of feature scores has been produced, an explanation can be crafted using information selected based, at least in part, on the vector of feature scores. Translating a vector of feature scores to an explanation may include defining a sentence structure that is composed of up to K slots. The sentence structure may include connective words for connecting features or feature categories. Translating a vector of feature scores to an explanation may also include deciding which features or feature categories will compete to appear in a slot in the sentence structure. Assembling the explanation may involve greedily selecting a fitting feature for a slot. Assembling the explanation may also include adding appropriate connective words before and after a slot. In one embodiment, if a feature has a negative score with a large absolute value, the feature may be used in a negative fashion. For example, an explanation may describe a feature as a non-XYZ (e.g., non-dramatic movie). A rule set may then be applied to the sentence that has been assembled as the explanation to any semantic or syntactic errors. The resulting sentence based explanation may provide a natural language interpretation of the significant features that contribute to the explanation.

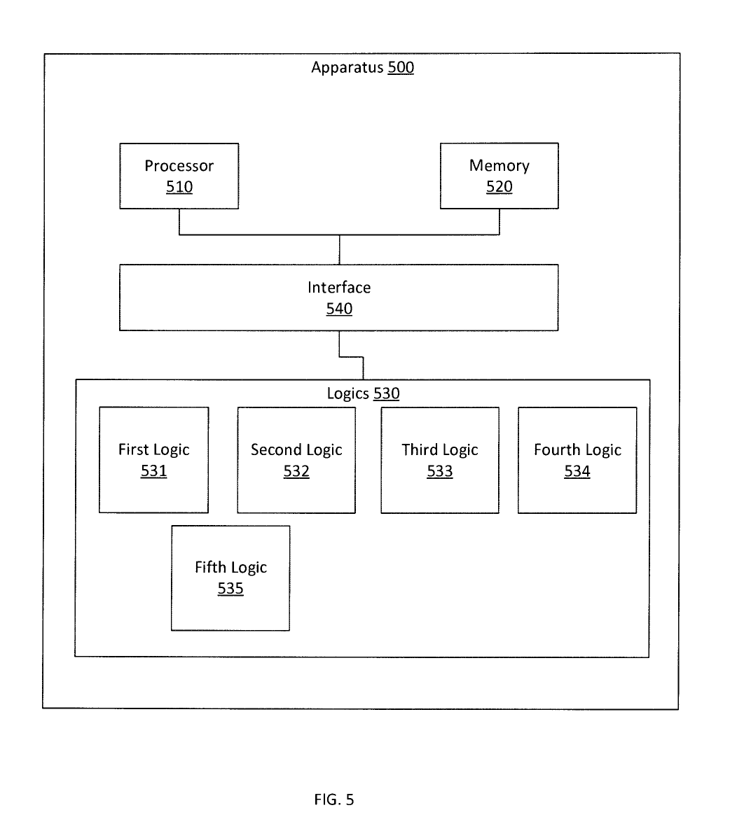

FIG. 5 illustrates an apparatus 500 that produces a hybrid explanation of a recommendation produced by a CF recommendation system. Apparatus 500 may include a processor 510, a memory 520, a set 530 of logics, and an interface 540 that connects the processor 510, the memory 520, and the set 530 of logics. The processor 510 may be, for example, a microprocessor in a computer, a specially designed circuit, a field-programmable gate array (FPGA), an application specific integrated circuit (ASIC), a processor in a mobile device, a system-on-a-chip, a dual or quad processor, or other computer hardware. The memory 520 may store electronic data associated with an item to be recommended by an automated collaborative filtering recommendation system.

In one embodiment, the apparatus 500 may be a general purpose computer that has been transformed into a special purpose computer through the inclusion of the set 530 of logics. Apparatus 500 may interact with other apparatus, processes, and services through, for example, a computer network. Apparatus 500 may be, for example, a computer, a laptop computer, a tablet computer, a personal electronic device, a smart phone, a system-on-a-chip (SoC), or other device that can access and process data.

In one embodiment, the functionality associated with the set of logics 530 may be performed, at least in part, by hardware logic components including, but not limited to, field-programmable gate arrays (FPGAs), application specific integrated circuits (ASICs), application specific standard products (ASSPs), system on a chip systems (SOCs), or complex programmable logic devices (CPLDs).

The set 530 of logics may produce an explanation of why the item is being recommended. The set 530 of logics may include a first logic 531 that identifies a personalization level for an item associated with the item being recommended. The personalization level may depend, at least in part, on the history of the user (e.g., items consumed). For example, the personalization level may be a function of how closely the item being recommended is related to an item in the user history. The personalization level may control, at least in part, which features are considered for the explanation. For example, only features in items that are within the neighborhood of the recommended item may be considered because there may be no point in considering features associated with items that are not similar to the item being recommended.

The set 530 of logics may also include a second logic 532 that determines a quality level of the descriptiveness of a feature with respect to explaining why the item is being recommended. The quality level may control, at least in part, which features are considered for the explanation. For example, only features that are useful for explaining the recommendation may be included in a hybrid explanation. Features that the item does not exhibit might be worthless for explaining the item and thus may not be used. In one embodiment, the labels for features (e.g., the actual text for the feature) might be human curated. In one embodiment, features that are used to explain the item may be scored based on how well they partition the set of recommendations. A feature that every item exhibits would not distinguish one item from another while a feature that is exhibited by a small number of related items may facilitate distinguishing one item from another item.

The set 530 of logics may also include a third logic 533 that determines correlations between items considered by the first logic 531 and features analyzed by the second logic 532. The correlations control, at least in part, which features are included in the explanation. The correlations between items and features reflect the degree to which the features are exhibited by the items.

The set 530 of logics may also include a fourth logic 534 that identifies features to be included in the explanation of why the item is being recommended. The fourth logic 534 may identify the features based on the personalization level, the quality level of the descriptiveness, and the correlations. In one embodiment, the fourth logic computes an aggregate feature score according to:

score=ΣwₚP×Σw_{c}C×Σw_{d}D

where:
wₚ is a weight factor,
P describes personalization levels for items associated with the item to be recommended,
w_{c} is a weight factor,
C describes correlations that measure the degree to which an item possesses a feature,
w_{d} is a weight factor, and
D describes descriptiveness levels for features associated with the item to be recommended.

The set 530 of logics may also include a fifth logic 535 that produces electronic data that identifies the item being recommended and the explanation of why the item is being recommended. The electronic data may describe recommendation sentences as described herein. In one embodiment, the fifth logic 535 selects feature categories to be included in the explanation based on the aggregate feature score. Similarly, the fifth logic 535 may select features to be included in the explanation based on the aggregate feature score. For example, the highest scoring feature categories and the highest scoring feature values may be selected for inclusion in the explanation.

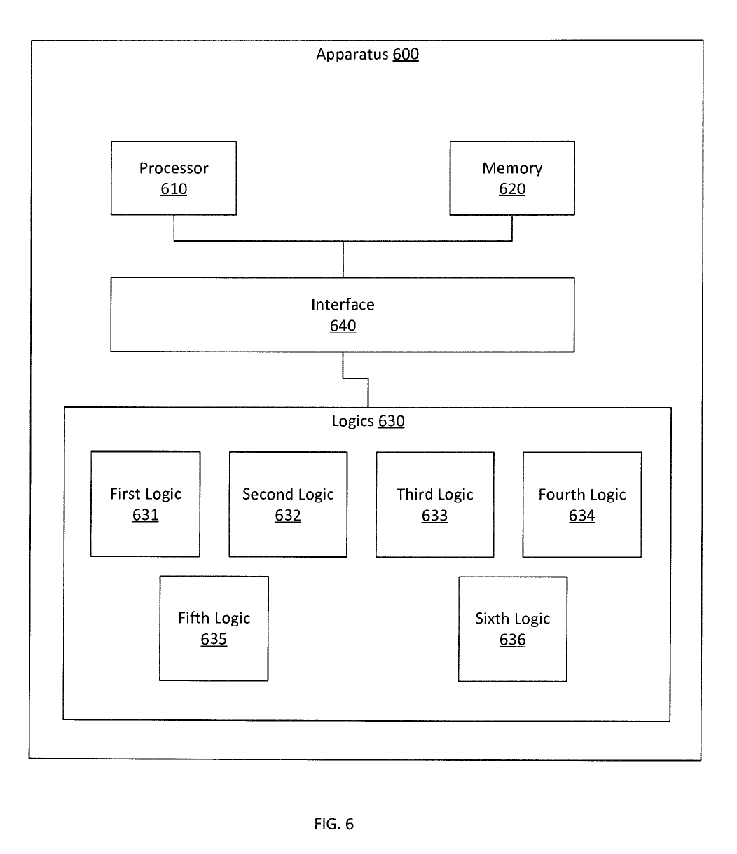

FIG. 6 illustrates an apparatus 600 that is similar to apparatus 500 (FIG. 5). For example, apparatus 600 includes a processor 610, a memory 620, a set of logics 630 (e.g., 631, 632, 633, 634, 635) that correspond to the set of logics 530 (FIG. 5) and an interface 640. However, apparatus 600 includes an additional sixth logic 636. Sixth logic 636 may selectively update wₚ, w_{c}, or w_{d} based on whether the user consumed the recommended item within a threshold period of time of receiving the explanation or based on a feedback provided by the user concerning the explanation. For example, if a user immediately purchased a recommended item after seeing the hybrid explanation, then weights that contributed to producing the feature scores that controlled the hybrid explanation may be maintained or increased. But if a user provided negative feedback (e.g., this recommendation was not useful to me, this recommendation seemed like it was intended for someone else) then the weights may be altered or diminished.

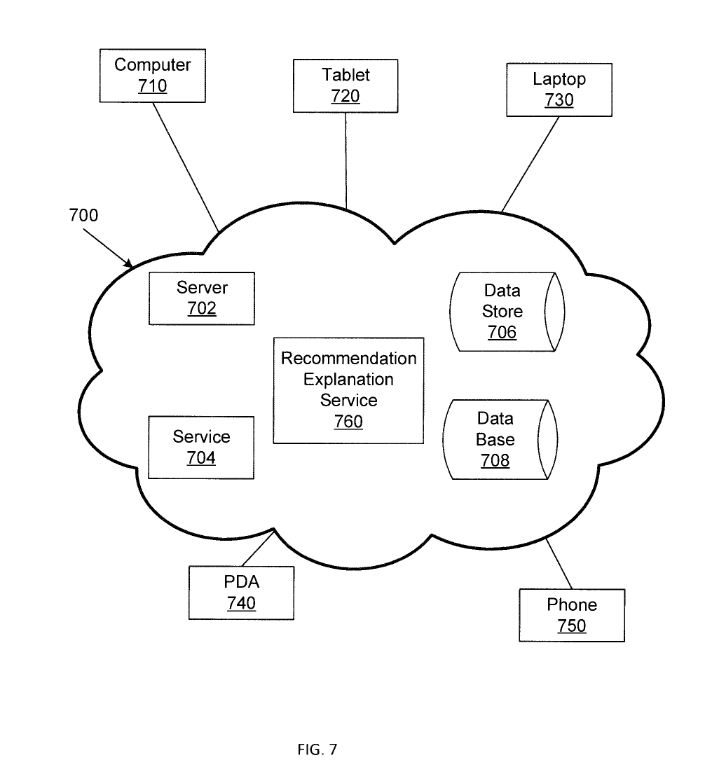

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example recommendation explanation service 760 residing in the cloud. The recommendation explanation service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the recommendation explanation service 760.

FIG. 7 illustrates various devices accessing the recommendation explanation service 760 in the cloud. The devices include a computer 710, a tablet 720, a laptop computer 730, a personal digital assistant 740, and a mobile device (e.g., cellular phone, satellite phone, wearable computing device) 750. The recommendation explanation service 760 may produce a hybrid recommendation explanation for a user concerning a potential acquisition (e.g., purchase, rental, borrowing). The recommendation explanation service 760 may produce data from which the hybrid recommendation explanation may be made.

It is possible that different users at different locations using different devices may access the recommendation explanation service 760 through different networks or interfaces. In one example, the recommendation explanation service 760 may be accessed by a mobile device 750. In another example, portions of recommendation explanation service 760 may reside on a mobile device 750.

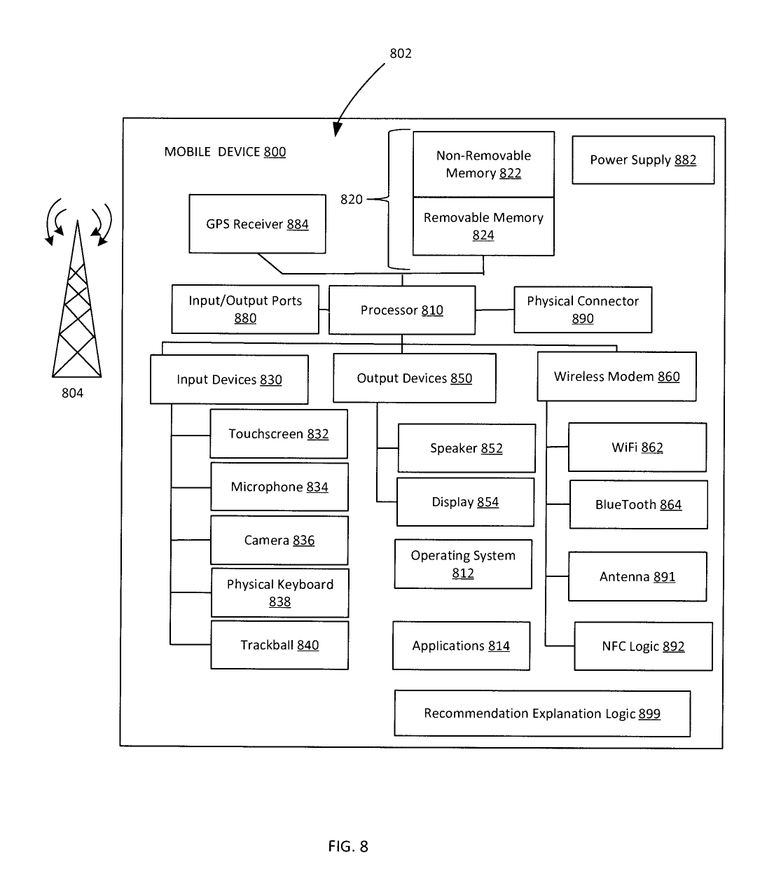

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), wearable computing device, etc.) and may allow wireless two-way communications with one or more mobile communications networks 804, such as a cellular or satellite network.

Mobile device 800 can include a controller or processor 810 (e.g., signal processor, microprocessor, ASIC, or other control and processing logic circuitry) for performing tasks including signal coding, data processing, input/output processing, power control, or other functions. An operating system 812 can control the allocation and usage of the components 802 and support application programs 814. The application programs 814 can include recommendation applications, matrix factorization applications, mobile computing applications (e.g., email applications, calendars, contact managers, web browsers, messaging applications), video games, or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is well known in GSM communication systems, or other memory storage technologies, such as “smart cards.” The memory 820 can be used for storing data or code for running the operating system 812 and the applications 814. Example data can include user vectors, item vectors, latent space data, recommendations, recommendation explanation, or other data. The memory 820 can be used to store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can include speech-recognition software as part of a voice user interface that allows a user to operate the device 800 via voice commands. Further, the device 800 can include input devices and software that allow for user interaction via a user's spatial gestures, such as detecting and interpreting gestures to provide input to a recommendation application.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). NFC logic 892 facilitates having near field communications (NFC).

The mobile device 800 may include at least one input/output port 880, a power supply 882, a satellite navigation system receiver 884, such as a Global Positioning System (GPS) receiver, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include recommendation explanation logic 899 that is configured to provide a functionality for the mobile device 800. For example, recommendation explanation 899 may provide a client for interacting with a service (e.g., service 760, FIG. 7). Portions of the example methods described herein may be performed by recommendation explanation 899. Similarly, recommendation explanation logic 899 may implement portions of apparatus described herein.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, distributions, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, system-on-a-chip (SoC), or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

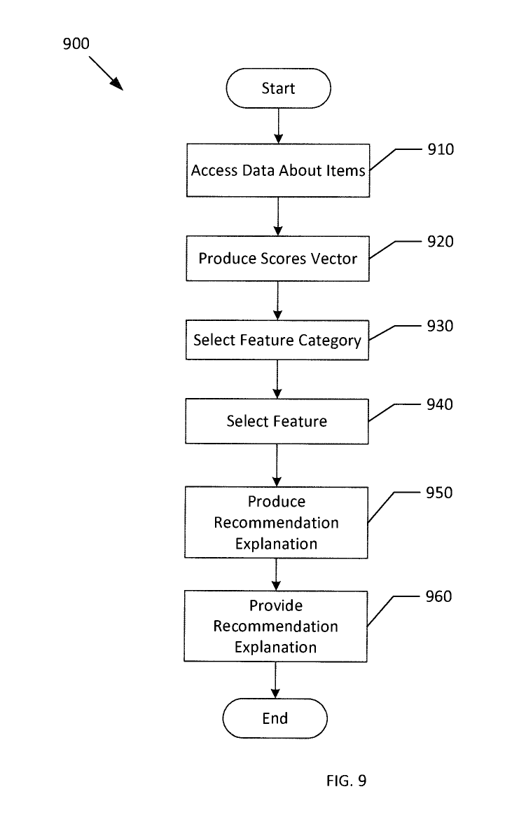

FIG. 9 illustrates an example method 900 associated with producing a hybrid explanation for a recommendation produced by a CF recommendation system. The explanation may be a “hybrid” explanation because it includes elements of a user-to-item recommendation based on distances between user and item vectors and may also include elements of an item-to-item recommendation based on similarities between features. Method 900 may include, at 910, accessing electronic data associated with a non-empty set of items that are candidates for being recommended to a user. The data is not something that can be perceived by a human and thus is not data that could be processed by a human. The data is not something that could be written on a piece of paper, and thus the data could not be processed using paper or pencil. For example, the non-empty set may be produced by an automated collaborative-filter based recommendation system. The non-empty set is a subset of an item space processed by the recommendation system. Membership in the non-empty set is based, at least in part, on a history of the user. Recall that the history of a user for a CF recommendation system identifies items previously consumed by the user. In a CF recommendation system, items have associated features, and thus members of the non-empty set of items collectively have m features associated with one or more feature categories, m being a number.

Method 900 may also include, at 920, producing electronic data that describes a scores vector. The scores vector is produced as a function of a relationship between the m features and the members of the set of items and of a relationship between the m features and the history. The relationship may combine aggregate scores. In one embodiment, the scores vector is computed according to:

S=Σwᵢ·Rᵢ^{1×n}×Σwⱼ·pⱼ^{n×m}·Σwₖ·Fₖ^{m×1}

where:
S represents the scores vector,
n represents the number of items in the set of items,
i represents an individual item in the item space,
j represents an individual feature in the m features,
wᵢ represents a configurable weight for item strengths,
wₖ represents a configurable weight for feature strengths,
wⱼ represents a configurable weight for correlations between items and features,
Rᵢ represents an item strength for an item i in the item space, where the item strength for the item i represents how related the item i is to an item in the set of items,
Fₖ represents a feature strength for a feature k, where the feature strength for the feature k represents how important the feature k is to describing an item in the set of items, and
Pⱼ represents a correlation between items and features.

In one embodiment, Ri depends on the history and varies inversely with the distance of an item in the item space from an item in the set of items. Having Ri vary inversely with the distance helps personalize the message by making sure that items in the history that are closest to the recommendation item are considered more important. In one embodiment, Fk is based, at least in part, on a curated value that represents a prior belief of the explanatory value of a feature. In one embodiment, Ri is an aggregation of two or more item strength determinations for the item i. Similarly, in one embodiment, Fk is an aggregation of two or more feature strength determinations for the feature k. In one embodiment, Pj is based, at least in part, on an affinity between a selected item and a selected feature. The affinity describes the extent to which the selected item exhibits the selected feature.

Method 900 may also include, at 930, selecting a feature category for inclusion in a recommendation explanation based, at least in part, on the scores vector. In one embodiment, selecting the feature category includes identifying a highest scored feature associated with the scores vector or identifying features associated with the scores vector whose values exceed a threshold.

Method 900 may also include, at 940, selecting a feature value for inclusion in the recommendation explanation based, at least in part, on the scores vector and the feature category. In one embodiment, selecting the feature value includes identifying a highest scored feature associated with the scores vector or identifying features associated with the scores vector whose values exceed a threshold.

Method 900 may also include, at 950, producing electronic data that describes the recommendation explanation. Electronic data cannot be produced by the human mind and cannot be produced by paper and pencil. In one embodiment, constructing the recommendation explanation includes selecting an order in which feature categories will be presented in the recommendation explanation. For example, highest scoring feature categories may be placed first in the recommendation explanation. Constructing the recommendation explanation may also include selecting an order in which feature values will be presented in the recommendation explanation. The order of the feature values may be determined, at least in part, by the order of the feature categories. Constructing the recommendation explanation may also include selecting connectors to be placed in the recommendation explanation based on the order of the feature categories and feature values.

Method 900 may also include, at 960, providing the recommendation explanation to the user. Since method 900 produces electronic data, the recommendation explanation is provided on a computerized device.

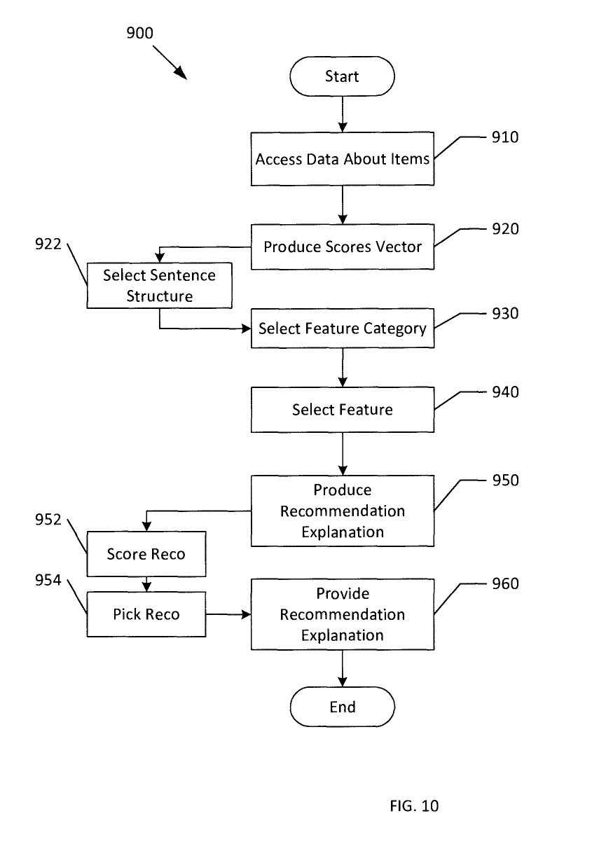

FIG. 10 illustrates another embodiment of method 900. This embodiment of method 900 may also include, at 922, selecting a sentence structure for the recommendation explanation. The sentence structure may be based, at least in part, on feature categories to be included. In one embodiment, the sentence structure includes one or more slots for feature categories and one or more slots for feature values. The sentence structure may also identify one or more feature categories that may compete for a feature category slot and may identify one or more features that may compete for a feature value slot.

This embodiment of method 900 may also include, at 952, producing individual scores for recommendation explanations for members of the set of items. The scores for the recommendation explanations may then be used to select an item to be recommended based on how well the recommendation can be explained. Thus, this embodiment of method 900 may also include, at 954, selecting an item to be recommended from the set of items based, at least in part, on the individual scores.

While FIGS. 9 and 10 illustrates various actions occurring in serial, it is to be appreciated that various actions illustrated in FIGS. 9 and 10 could occur substantially in parallel. By way of illustration, a first process could compute feature scores and a second process could construct recommendation explanations. While two processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including method 900. While executable instructions associated with the above methods are described as being stored on a computer-readable storage medium, it is to be appreciated that executable instructions associated with other example methods described or claimed herein may also be stored on a computer-readable storage medium. In different embodiments the example methods described herein may be triggered in different ways. In one embodiment, a method may be triggered manually by a user. In another example, a method may be triggered automatically.

### Aspects of Certain Embodiments

In one embodiment, an apparatus includes a processor, a memory, and a set of logics. The apparatus may include a physical interface to connect the processor, the memory, and the set of logics. The memory stores electronic data associated with an item to be recommended by an automated collaborative filtering (ACF) recommendation system. The ACF recommendation system analyzes items having features for a user having a history of items consumed. The set of logics produces an explanation of why the item is being recommended. The set of logics includes a first logic that identifies a personalization level for an item associated with the item being recommended, where the personalization level depends, at least in part, on the history, and where the personalization level controls, at least in part, which features are considered for the explanation. The set of logics includes a second logic that determines a quality level of the descriptiveness of a feature with respect to explaining why the item is being recommended, where the quality level controls, at least in part, which features are considered for the explanation. The set of logics includes a third logic that determines correlations between items considered by the first logic and features analyzed by the second logic, where the correlations control, at least in part, which features are included in the explanation. The set of logics includes a fourth logic that identifies features to be included in the explanation of why the item is being recommended based on the personalization level, the quality level of the descriptiveness, and the correlations. The set of logics includes a fifth logic that produces electronic data that identifies the item being recommended and the explanation of why the item is being recommended. The apparatus may produce a new type of recommendation explanation and may produce that hybrid explanation faster and more accurately than conventional systems due to the aggregate feature score approach described herein. The apparatus may store less data than a conventional system because once a good explanatory sentence has been crafted, underlying data used to build the sentence may be released.

In one embodiment, a method includes accessing electronic data associated with a non-empty set of items that are candidates for being recommended to a user. The non-empty set is produced by an automated collaborative-filter based recommendation system. The non-empty set is a subset of an item space processed by the recommendation system. Membership in the non-empty set is based, at least in part, on a history of the user, where the history identifies one or more items previously consumed by the user, and where members of the non-empty set of items collectively have m features associated with one or more feature categories, m being a number. The method may include producing electronic data that describes a scores vector. The scores vector is a function of a relationship between the m features and the members of the set of items and of a relationship between the m features and the history. The method may include selecting a feature category for inclusion in a recommendation explanation based, at least in part, on the scores vector and selecting a feature value for inclusion in the recommendation explanation based, at least in part, on the scores vector and the feature category. The method may also include producing electronic data that describes the recommendation explanation, and providing the recommendation explanation to the user. The recommendation explanation is provided on a computerized device.

In one embodiment, a computer-readable storage medium may store computer-executable instructions that when executed by a computer control the computer to perform a method. The method may include providing a user-to-item recommendation from a collaborative filter based recommendation system and providing a personalized message to accompany and explain the user-to-item recommendation. The personalized message includes feature information taken from a user consumption history. The method may also include measuring a response to the personalized message with respect to a user satisfaction metric and selectively updating how the personalized message is produced based on the response.

### DEFINITIONS

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
a processor;
a memory that stores electronic data associated with an item to be recommended by an automated collaborative filtering (ACF) recommendation system, where the ACF recommendation system analyzes items having features for a user having a history of items consumed;
a set of logics that produce a hybrid explanation of why the item is being recommended; and
an interface to connect the processor, the memory, and the set of logics;
the set of logics comprising:
a first logic that identifies a personalization level for an item associated with the item being recommended, where the personalization level depends, at least in part, on the history, and where the personalization level controls, at least in part, which features are considered for the hybrid explanation;
a second logic that determines a quality level of the descriptiveness of a feature with respect to explaining why the item is being recommended, where the quality level controls, at least in part, which features are considered for the hybrid explanation;
a third logic that determines correlations between items considered by the first logic and features analyzed by the second logic, where the correlations control, at least in part, which features are included in the hybrid explanation;
a fourth logic that identifies features to be included in the hybrid explanation of why the item is being recommended based on the personalization level, the quality level of the descriptiveness, and the correlations; and
a fifth logic that produces electronic data that identifies the item being recommended and the hybrid explanation of why the item is being recommended.

2. The apparatus of claim 1, where the personalization level is a function of how closely the item being recommended is related to an item in the user history.

3. The apparatus of claim 2, where the quality level is human curated.

4. The apparatus of claim 2, where the quality level varies directly with the ability of the feature to partition a feature space.

5. The apparatus of claim 4, where the correlations between items and features reflect the degree to which the features are exhibited by the items.

6. The apparatus of claim 5, where the fourth logic computes an aggregate feature score according to:
score=ΣwₚP×Σw_{c}C×Σw_{d}D
where:
wₚ is a weight factor,
P describes personalization levels for items associated with the item to be recommended,
w_{c} is a weight factor,
C describes correlations that measure the degree to which an item possesses a feature,
w_{d} is a weight factor, and
D describes descriptiveness levels for features associated with the item to be recommended.

7. The apparatus of claim 6, where the fifth logic selects feature categories to be included in the hybrid explanation based on the aggregate feature score.

8. The apparatus of claim 7, where the fifth logic selects features to be included in the hybrid explanation based on the aggregate feature score.

9. The apparatus of claim 1, comprising a sixth logic that selectively updates wₚ, w_{c}, or w_{d} based on whether the user consumed the recommended item within a threshold period of time of receiving the hybrid explanation or based on a feedback provided by the user concerning the hybrid explanation.

10. A method, comprising:
accessing electronic data associated with a non-empty set of items that are candidates for being recommended to a user, where the non-empty set was produced by an automated collaborative-filter based recommendation system, where the non-empty set is a subset of an item space processed by the recommendation system, where membership in the non-empty set is based, at least in part, on a history of the user, where the history identifies one or more items previously consumed by the user, and where members of the non-empty set of items collectively have m features associated with one or more feature categories, m being a number;
producing electronic data that describes a scores vector, where the scores vector is a function of a relationship between the m features and the members of the set of items and of a relationship between the m features and the history;
selecting a feature category for inclusion in a hybrid recommendation explanation based, at least in part, on the scores vector;
selecting a feature value for inclusion in the hybrid recommendation explanation based, at least in part, on the scores vector and the feature category;
producing electronic data that describes the hybrid recommendation explanation, and
providing the hybrid recommendation explanation to the user, where the hybrid recommendation explanation is provided on a computerized device.

11. The method of claim 10, where selecting the feature category includes identifying a highest scored feature associated with the scores vector or identifying features associated with the scores vector whose values exceed a threshold, and where selecting the feature value includes identifying a highest scored feature associated with the scores vector or identifying features associated with the scores vector whose values exceed a threshold.

12. The method of claim 10, where the scores vector is computed according to:
S=Σwᵢ·Rᵢ^{1×n}×Σwⱼ·pⱼ^{n×m}·Σwₖ·Fₖ^{m×1}
where:
S represents the scores vector,
n represents the number of items in the set of items,
i represents an individual item in the item space,
j represents an individual feature in the m features,
wᵢ represents a configurable weight for item strengths,
wₖ represents a configurable weight for feature strengths,
wⱼ represents a configurable weight for correlations between items and features,
Rᵢ represents an item strength for an item i in the item space, where the item strength for the item i represents how related the item i is to an item in the set of items,
Fₖ represents a feature strength for a feature k, where the feature strength for the feature k represents how important the feature k is to describing an item in the set of items, and
Pᵢ represents a correlation between items and features.

13. The method of claim 12, where Ri depends on the history and where Ri varies inversely with the distance of an item in the item space from an item in the set of items.

14. The method of claim 12, where Fk is based, at least in part, on a curated value that represents a prior belief of the explanatory value of a feature.

15. The method of claim 12, where Pj is based, at least in part, on an affinity between a selected item and a selected feature, where the affinity describes the extent to which the selected item exhibits the selected feature.

16. The method of claim 12, where Ri is an aggregation of two or more item strength determinations for the item i or where Fk is an aggregation of two or more feature strength determinations for the feature k.

17. The method of claim 10, comprising selecting a sentence structure for the hybrid recommendation explanation based, at least in part, on the feature category, where the sentence structure includes one or more slots for feature categories and one or more slots for feature values, and where the sentence structure identifies one or more feature categories that may compete for a feature category slot and where the sentence structure identifies one or more features that may compete for a feature value slot.

18. The method of claim 17, where constructing the hybrid recommendation explanation includes selecting an order in which feature categories will be presented in the hybrid recommendation explanation, selecting an order in which feature values will be presented in the hybrid recommendation explanation, or selecting connectors to be placed in the hybrid recommendation explanation based on the order of the feature categories and feature values.

19. The method of claim 10, comprising:
producing individual scores for hybrid recommendation explanations for members of the set of items, and
selecting an item to be recommended from set of items based, at least in part, on the individual scores.

20. A computer-readable storage medium storing computer-executable instructions that when executed by a computer control the computer to perform a method, the method comprising:
providing a user-to-item recommendation from a collaborative filter based recommendation system;
providing a personalized message to accompany and explain the user-to-item recommendation, where the personalized message includes feature information taken from items in a user consumption history;
measuring a response to the personalized message with respect to a user satisfaction metric, and
selectively updating how the personalized message is produced based on the response.
